(19) United States
(12) Patent Application Publication
(10) Pub. No.: US 2002/0039431 A1
(43) Pub. Date: Apr. 4, 2002

(54) Dual magnetic field speaker

(76) Inventor: Dino Chang, Taipei (TW)

Correspondence Address: Eugene Mar, BACON & THOMAS, PLLC, Fourth Floor, 625 Slaters Lane, Alexandria, VA, 22314-1176, US

(21) Appl. No.: 09/994,727

(22) Filed: Nov. 28, 2001

Related U.S. Application Data
(63) Continuation-in-part of application No. 09/589,092, filed on Jun. 8, 2000.

(51) Int. Cl. H04R 1/00; H04R 11/02

(52) U.S. Cl. 381/412; 381/414; 381/400; 381/401

(57) ABSTRACT

A dual magnetic field speaker. The speaker includes two magnets, two yokes, two plates, and a voice coil having an upper winding and a lower winding disposed in an air gap. The speaker generates a constant intensity of magnetic flux that produces two monostable magnetic fields.

### CROSS-REFERENCE TO THE RELATED APPLICATION

The present invention is a Continuation-In-Part of U.S. patent application Ser. No. 09/589.092, filed on Jun. 8, 200, entitled “Dual Magnetic Field Type Speaker”, nor abandoned.

### BACKGROUND OF THE INVENTION

1. Field of the Invention

The present invention relates to speakers, and more particularly to such a speaker that produces two magnetic fields to improve its electric sound quality when operated.

2. Description of the Related Art

A conventional speaker, as shown in FIG. 1, is generally comprised of a magnet 11, a yoke 12, and a plate 13. The magnetic flux distribution in the annular air gap of this structure of speaker is shown in FIG. 2 where the magnetic filed is uniformly distributed in the middle area in the air gap, the distribution of the magnetic filed in the upper area and the distribution of the magnetic field in the lower area are relatively reduced and not symmetrical. When the voice coil vibrates in the upper area and the lower area, a non-linear variation of the intensity of magnetic induction is produced, thereby causing the voice coil to produce a non-linear distortion. In order to minimize the distortion due to uneven distribution of the magnetic field, the winding method of the voice coil is changed. As illustrated in FIG. 3, the voice coil 2 is comprised of an enabled wire 21 wound round a frame of paper, chemical film or metal. The winding is a single layer winding, and the voice coil 2 can be made in either of the following two forms:

1. The short voice coil design as shown in FIG. 4, i.e., b≦a−2s (s: amplitude of the voice coil), in which the winding range of the voice coil 2 is shorter than the thickness of the plate 13, limiting the vibration range of the voice coil 2 to the range within the area in the air gap where the magnetic field is evenly distributed. Because this design requires a relatively bigger and thicker plate 12 and a relatively bigger and thicker magnet 11, the manufacturing cost of the voice coil 2 is high.

2. The long voice coil design as shown in FIG. 5, i.e., b≧a+2s, in which the winding range of the voice coil 2 is greater than the thickness of the plate 13, keeping the magnetic flux in the air gap to be maintained within the vibration range of the voice coil, so as to prevent a distortion due to an uneven distribution of the magnetic field. The drawback of this design is its heavy weight. Because the plate 13 must have a big diameter to receive the voice coil, the magnetic gap is relatively bigger, however the total magnetic flux is relatively weaker, thereby causing the efficiency of the speaker to be relatively reduced.

During the operation of the speaker, as shown in FIG. 4, the magnet 11 produces a uniform magnetic field, the plate 13 and the yoke 12 form a magnetic loop, and an annular air gap (magnetic air gap) exists in between the plate 13 and the yoke 12. The voice coil 3 is suspended in the annular air gap. The magnet has two fixed poles, namely, S pole and N pole. Under the effect of the magnet 11, a uniform magnetic field is produced in the annular air gap, and the magnetic lines of force extend from N pole toward S pole, i.e., from the yoke 12 toward the plate 13. When audio frequency electric current passes through the voice coil 3, the voice coil 3 moves in the direction of the thumb, which is disposed perpendicular to the other fingers that are aimed at N pole, i.e., the voice coil 3 receives an upward force F, which is in directly proportional to the electric current I passing through the voice coil 3, the density of magnetic induction B in the magnetic air gap and the equivalent total length L of the wire of the voice coil 3, or F =B×I×L. The total length L is constant once it was decided during the designing of the speaker. Therefore, when audio frequency signal current passes through the voice coil 3, the voice coil 3 receives a force, which is directly proportional to the audio frequency signal current. Because the voice coil 3 is fixedly fastened to the diaphragm, the diaphragm is driven to move ambient air when the voice coil 3 vibrates, thereby producing sounds.

### SUMMARY OF THE INVENTION

The present invention has been accomplished to provide a dual magnetic field type speaker, which eliminates the aforesaid drawbacks. According to one aspect of the present invention, the speaker comprises two magnets, two yokes and two plates for producing two monostable magnetic fields to increase the density of magnetic flux and, to improve the sound quality. According to another aspect of the present invention, the voice coil comprises an upper winding and a lower winding disposed in a respective constant magnetic flux in a magnetic air gap to match with two magnetic fields, so as to eliminate non-linear distortion caused by the driving magnetic circuit.

### BRIEF DESCRIPTION OF THE DRAWINGS

FIG. 1 illustrates the arrangement of a magnetic loop in a speaker according to the prior art.

FIG. 2 is a schematic drawing showing the action of the magnetic loop in the speaker according to the prior art.

FIG. 3 illustrates the structure of the voice coil for the speaker according to the prior art.

FIG. 4 illustrates a short voice coil design according to the prior art.

FIG. 5 illustrates a long voice coil design according to the prior art.

FIG. 6 illustrates the arrangement of a magnetic loop in a speaker according to the present invention.

FIG. 7 is a schematic drawing showing the action of the magnetic loop according to the present invention.

FIG. 8 illustrates a dual-winding voice coil according to the present invention.

FIG. 9 illustrates the relation between the dual-winding voice coil, the magnets, and the yokes according to the present invention.

FIG. 10 illustrates the action of the present invention.

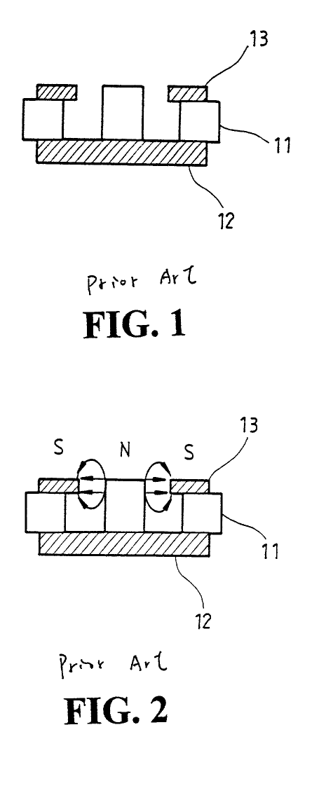

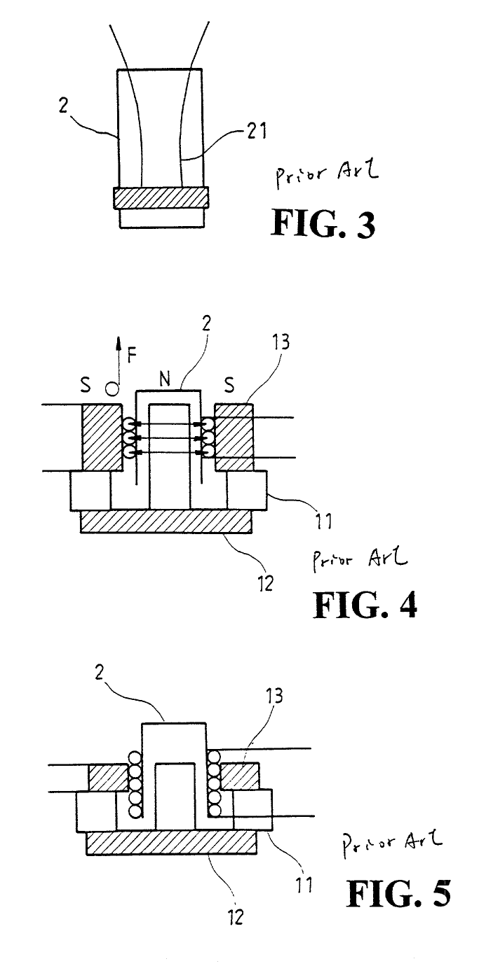

### DETAILED DESCRIPTION OF THE PREFERRED EMBODIMENT

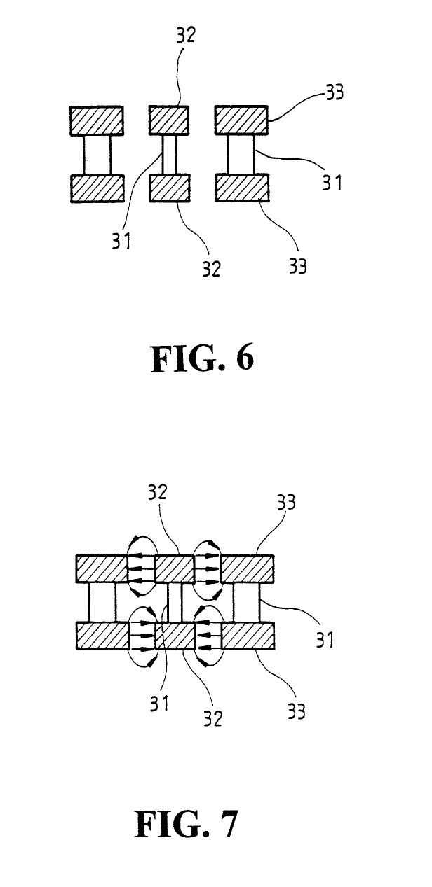

Referring to FIGS. 6 and 7, a speaker in accordance with the present invention comprises two magnets 31, two yokes 32 and two plates 33, and adapted to produce two monostable magnetic fields, keeping the magnetic fields to be evenly distributed in the air gap, so as to improve the density of the magnetic fields and the sound quality of the speaker.

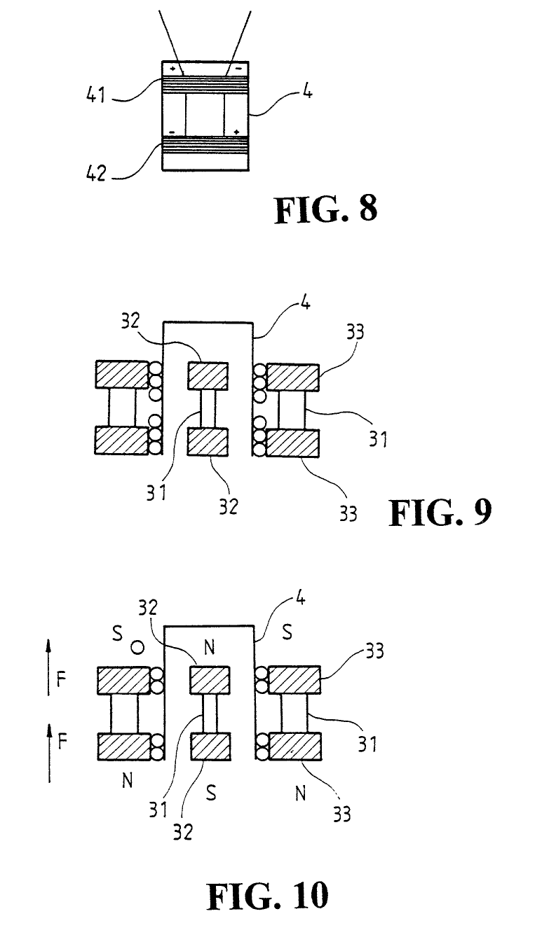

Referring to FIG. 8, the voice coil 4 comprises an upper winding 41 and a lower winding 42 wound on a plastic frame, keeping the windings 41 and 42 to be respectively disposed in a magnetic gap having sufficient intensity of magnetic flux.

Referring to FIG. 9, because the windings 41 and 42 of the double-winding voice coil 4 are shorter than the plates 33, the voice coil 4 has a light weight and high intensity of magnetic flux. When the voice coil 4 is vibrated, the windings 41 and 42 are controlled within the uniform magnetic fields, therefore the effective bandwidth is extended to eliminate distortion, and to improve the efficiency of the speaker.

Referring to FIG. 10, the upper magnetic loop of the present invention is same as conventional speakers, however, the lines of magnetic force of the lower magnetic field are reversed to that of the upper magnetic filed. In order to let the upper winding 41 and the lower winding 42 of the voice coil 4 be moved in same direction, electric current is transmitted to the upper winding 41 and the lower winding 42 in reversed directions. When audio frequency current signal is changed, the force receiving direction of the voice coil 4 is relatively changed. The two magnetic fields of the voice coil 4 serve as two driving systems in a car that enhances the movement, minimizes the distortion, and improves the efficiency.

What the invention claimed is:

1. A dual magnetic field speaker comprising:
a central magnet comprising an upper part of a first polarity and a lower part of a second polarity opposite the first polarity;
a first yoke positioned on the upper part of the central magnet;
a second yoke positioned on the lower part of the central magnet;
an outer magnet in circumferential relationship to the central magnet, the outer magnet having an upper part of the second polarity and a lower part of the first polarity;
a first plate positioned on the upper part of the outer magnet;
a second plate positioned on the lower part of the outer magnet;
an air gap formed between the central and outer magnets, the air gap between the first yoke and the first plate, the air gap between the second yoke and the second plate, so as to produce a first magnetic field between the first yoke and the first plate, and a second magnetic filed between the second yoke and the second plate, the magnetic fields being monostable and without non-linear distortion; and
a voice coil wound on a plastic frame and disposed in the air gap, the voice coil comprising upper and lower windings, the upper layer is wound around the voice coil in one direction between the first yoke and the first plate, and the lower layer is wound around the voice coil in a reverse direction between the second yoke and the second plate, the upper and lower windings of the voice coil are connectable to a source of electric current, such that electric current is transmitted to the upper and lower windings in reverse directions.
